(19) United States
(12) Patent Application Publication
(10) Pub. No.: US 2025/0168753 A1
(43) Pub. Date: May 22, 2025

(54) VIRTUAL ACCESS POINT ASSIGNMENT TO MULTIPLE BASIC SERVICE SET IDENTIFIER SETS BASED ON PHYSICAL MODE

(71) Applicant: Cisco Technology, Inc., San Jose, CA (US)

(72) Inventor: Venkataprasad CHIRREDDY, Milpitas, CA (US)

(21) Appl. No.: 18/517,993

(22) Filed: Nov. 22, 2023

(51) Int. Cl. H04W 48/16; H04W 48/20

(52) U.S. Cl. CPC H04W 48/16; H04W 48/20

(57) ABSTRACT

Systems and techniques for dynamically assigning virtual access points (VAPs) to multiple basic service set identifier (MBSSID) sets are described. An example technique includes generating a set of VAPs, where each VAP of the set of VAPs has a non-configured state. A first VAP configuration is received and includes an indication of a physical (PHY) mode associated with the first VAP configuration. A first VAP of the set of VAPs is assigned to a first MBSSID set, based at least in part on the PHY mode. The first VAP is configured according to the first VAP configuration.

### TECHNICAL FIELD

Embodiments presented in this disclosure generally relate to wireless communication. More specifically, embodiments disclosed herein relate to dynamically (re) assigning virtual access points (VAPs) to multiple basic service set identifier (MBSSID) sets based on the physical (PHY) mode of the VAP(s).

### BACKGROUND

Wireless communication standards, such as the Institute of Electrical and Electronics Engineers (IEEE) 802.11 technical standard, are continuing to evolve to meet the ever increasing demands of bandwidth intensive and low latency services, such as augmented/extended reality and cloud gaming, as illustrative, non-limiting examples. For example, recent amendments to IEEE 802.11 (e.g., IEEE 802.11ax amendment, IEEE 802.11be amendment, etc.) aim to introduce higher data rates using higher modulation orders, larger channel widths, and additional spatial streams, as well as a set of features such multi-link operation (MLO) and virtual access point (VAP) functionality, as illustrative, non-limiting examples.

MLO enables multi-link devices (MLDs), such as AP MLDs and station (STA) MLDs, to simultaneously send and receive data across different frequency bands and channels. With MLO, multiple links can be established between the STA MLD and AP MLD to increase throughput, reduce latency, and improve reliability. With VAP functionality, a single apparatus may be configured to operate multiple virtual access points (APs). A VAP is a logical entity that resides within the physical apparatus. Each virtual AP may be associated with a different basic service set identifier (BSSID).

### BRIEF DESCRIPTION OF THE DRAWINGS

So that the manner in which the above-recited features of the present disclosure can be understood in detail, a more particular description of the disclosure, briefly summarized above, may be had by reference to embodiments, some of which are illustrated in the appended drawings. It is to be noted, however, that the appended drawings illustrate typical embodiments and are therefore not to be considered limiting; other equally effective embodiments are contemplated.

FIG. 1 illustrates an example system, according to one embodiment.

FIG. 2 illustrates an example architecture of a MLD, according to one embodiment.

FIG. 3 is a flowchart of a method for (re) assigning a VAP to a MBSSID set, based on PHY mode, according to one embodiment.

FIG. 4 is a flowchart of another method for (re) assigning a VAP to a MBSSID set, based on PHY mode, according to one embodiment.

FIG. 5 is a flowchart of another method for (re) assigning a VAP to a MBSSID set, based on PHY mode, according to one embodiment.

FIG. 6 illustrates an example computing device, according to one embodiment.

To facilitate understanding, identical reference numerals have been used, where possible, to designate identical elements that are common to the figures. It is contemplated that elements disclosed in one embodiment may be beneficially used in other embodiments without specific recitation.

### DESCRIPTION OF EXAMPLE EMBODIMENTS

### Overview

One embodiment described herein is a computer-implemented method. The computer-implemented method includes generating a set of virtual access points (VAPs). Each VAP of the set of VAPs has a non-configured state. The computer-implemented method also includes receiving a first virtual access point (VAP) configuration. The first VAP configuration includes an indication of a physical (PHY) mode associated with the first VAP configuration. The computer-implemented method also includes assigning a first VAP of the set of VAPs to a first multiple basic service set identifier (MBSSID) set, based at least in part on the PHY mode. The computer-implemented method further includes configuring the first VAP according to the first VAP configuration.

Another embodiment described herein is a computing device. The computing device includes one or more memories collectively storing computer-executable instructions, and one or more processors coupled to the one or more memories. The one or more processors are collectively configured to execute the computer-executable instructions to cause the computing device to perform an operation. The operation includes generating a set of virtual access points (VAPs). Each VAP of the set of VAPs has a non-configured state. The operation also includes receiving a first virtual access point (VAP) configuration. The first VAP configuration includes an indication of a physical (PHY) mode associated with the first VAP configuration. The operation further includes assigning a first VAP of the set of VAPs to a first multiple basic service set identifier (MBSSID) set, based at least in part on the PHY mode. The operation further includes configuring the first VAP according to the first VAP configuration.

Another embodiment described herein includes one or more non-transitory computer-readable storage media containing, in any combination, computer-executable instructions that, when executed by a computing system, perform an operation. The operation includes generating a set of virtual access points (VAPs). Each VAP of the set of VAPs has a non-configured state. The operation also includes receiving a first virtual access point (VAP) configuration. The first VAP configuration includes an indication of a physical (PHY) mode associated with the first VAP configuration. The operation further includes assigning a first VAP of the set of VAPs to a first multiple basic service set identifier (MBSSID) set, based at least in part on the PHY mode. The operation further includes configuring the first VAP according to the first VAP configuration.

### EXAMPLE EMBODIMENTS

Embodiments described herein provide techniques for (re) assigning VAP(s) to MBBSSID sets based on a respective physical mode associated with the VAP(s). The techniques described herein may allow for reducing (or preventing) interoperability issues between wireless devices that operate according to different versions of a wireless communication standard.

In some cases, for example, when a current wireless device that supports a newer version of a wireless communication standard (e.g., 802.11be) is deployed with a legacy wireless device that supports an older version of the wireless communication standard (802.11ax), the current wireless device may run into interoperability issues with the legacy wireless device. In such cases, the current wireless device may switch its configuration to operate according to the older version of the wireless communication device to improve interoperability with the legacy devices. As a reference example, in 802.11be, when a VAP is removed from an AP MLD, the VAP can be disabled or can be reconfigured (or repurposed) to operate according to 802.11ax to allow legacy client STAs to associate with the VAP.

However, in certain frequency bands, such as the 6 GHz band, repurposing or reconfiguring a VAP can impact other features supported by a wireless communication standard, such as 802.11be. For example, an AP MLD that operates according to 802.11be (referred to hereinafter as an 802.11be AP) may support up to 16 VAPs. The 16 VAPs may be distributed to 4 MBSSID sets where each MBBSSID supports up to 4 VAPs. In order to comply with the 802.11be standard, the VAPs in a given MBSSID set should have (i) the same VAP PHY mode and (ii) contiguous BSSID media access control (MAC) addresses. As such, when a given VAP is reconfigured (or repurposed) to operate according to a different wireless communication standard, such as 802.11ax or 802.11be, it may not be able to remain in the same MBSSID set since the VAP's PHY mode may be different than the MBSSID set's PHY mode. In such a scenario, the VAP may have to be moved to another MBSSID set.

Conventional techniques for managing MBSSID sets generally involve either reserving MBSSID sets for different PHY modes or creating shadow MBSSID sets to accommodate reconfigured VAPs. Reserving MBSSID sets for different PHY modes, however, can limit the number of VAPs since a number of MBSSID sets have to be reserved for reconfigured VAPs. Additionally, since creating additional MBSSID sets can involve using additional MAC addresses, this technique can lead to inefficient use of resources, as the number of unique MAC addresses assigned per AP may be limited.

To address this, certain embodiments described herein provide techniques for dynamically (re) assigning a VAP to a MBSSID set based on the PHY mode of the VAP. The VAPs may be distributed to different MBSSID sets such that (i) the maximum number of VAPs (allowed by a wireless communication standard) can be supported without the need for reserving any MBSSID sets for reconfigured VAPs and (ii) other VAPs are not impacted when a given VAP's PHY mode changes.

Note, the techniques described herein for dynamically (re) assigning VAPs to MBSSID sets based on a PHY mode may be incorporated into (such as implemented within or performed by) a variety of wired or wireless apparatuses (such as nodes). In some implementations, a node includes a wireless node. Such wireless nodes may provide, for example, connectivity to or for a network (such as a wide area network (WAN) such as the Internet or a cellular network) via a wired or wireless communication link. In some implementations, a wireless node may include an AP or a controller.

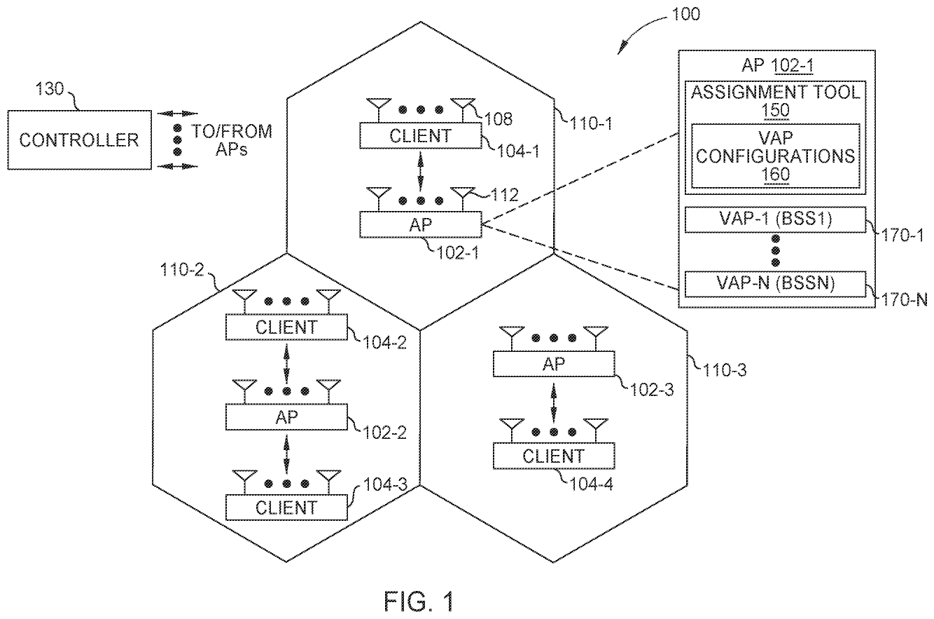

FIG. 1 illustrates an example system 100 in which one or more techniques described herein can be implemented, according to one embodiment. As shown, the system 100 includes one or more APs (e.g., AP 102-1, AP 102-2, and AP 102-3), one or more client STAs (e.g., client STA 104-1, client STA 104-2, client STA 104-3, and client STA 104-4), and a controller 130. An AP is generally a fixed station that communicates with client STA(s) and may be referred to as a base station, wireless device, or some other terminology. A client STA may be fixed or mobile and also may be referred to as a mobile STA, a client, a STA, a wireless device, or some other terminology. Note that while a certain number of APs and client STAs are depicted, the system 100 may include any number of APs and client STAs.

As used herein, an AP along with the STAs associated with the AP (e.g., within the coverage area (or cell) of the AP) may be referred to as a basic service set (BSS). Here, AP 102-1 is the serving AP for client STA 104-1, AP 102-2 is the serving AP for client STAs 104-2 and 104-3, and AP 102-3 is the serving AP for client STA 104-4. The AP 102-1, AP 102-2, and AP 102-3 are neighboring (peer) APs. The APs 102 may communicate with one or more client STAs 104 on the downlink and uplink. The downlink (e.g., forward link) is the communication link from the AP 102 to the client STA(s) 104, and the uplink (e.g., reverse link) is the communication link from the client STA(s) 104 to the AP 102. In some cases, a client STA may also communicate peer-to-peer with another client STA.

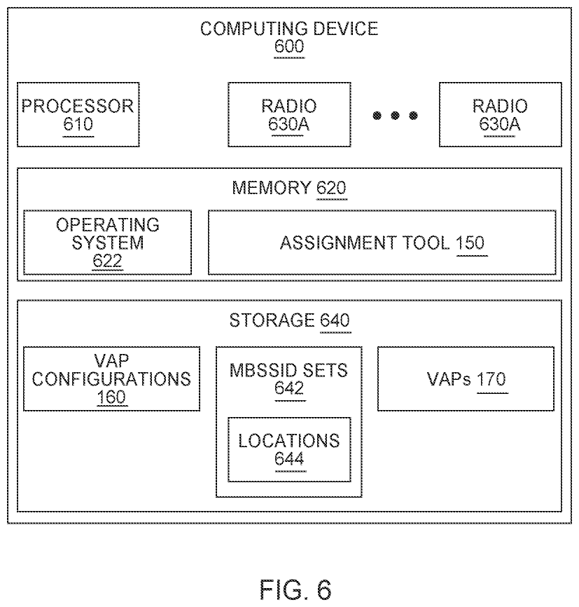

As shown in FIG. 1, each client STA 104 includes one or more radios 108. The client STA 104 can use one or more of the radios 108 to form links with an AP 102. As also shown, each AP 102 includes one or more radios 112 that the AP 102 can use to form links with one or more client STAs 104. In general, the AP(s) 102 and the client STA(s) 104 may form any suitable number of links for communication using any suitable frequencies. In some instances, a client STA 104 may form multiple links with a single AP 102. Example hardware that may be included in an AP 102 is discussed in greater detail in regard to FIG. 6.

The controller 130 couples to and provides coordination and control for the APs 102 1-3. For example, the controller 130 may handle adjustments to RF power, channels, authentication, and security for the APs. The controller 130 may also coordinate the links formed by the client STA(s) 104 with the APs 102. In certain embodiments described herein, the controller 130 may configure one or more of the APs 102 with one or more VAP configurations.

In certain embodiments, the controller 130 is included within or integrated with an AP 102 and coordinates the links formed by that AP 102 (or otherwise provides control for that AP). For example, each AP 102 may include a controller that provides control for that AP. In some embodiments, the controller 130 is separate from the APs 102 and provides control for those APs. In FIG. 1, for example, the controller 130 may communicate with the APs 102 1-3 via a (wired or wireless) backhaul. The APs 102 1-3 may also communicate with one another, e.g., directly or indirectly via a wireless or wireline backhaul. Example hardware that may be included in a controller 130 is discussed in greater detail with regard to FIG. 6.

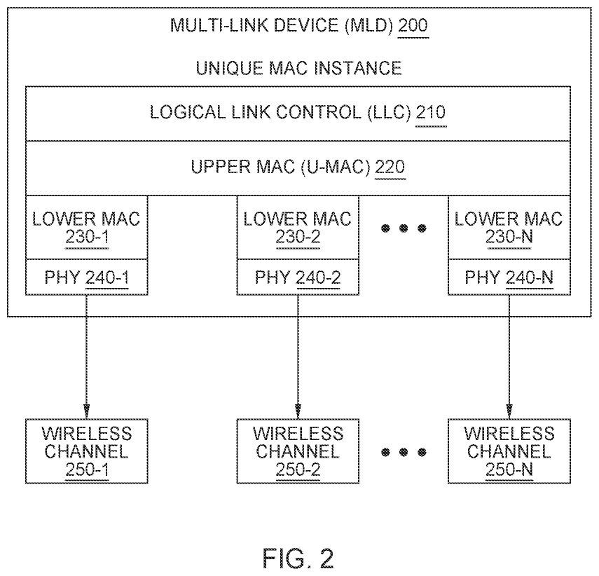

Note, that in certain embodiments, one or more of the client STAs 104 may be referred to as STA multi-link devices (MLDs) (e.g., a STA or client device acting as a MLD) and/or one or more of the APs 102 may be referred to as AP MLDs (e.g., an AP that acts as a MLD). The STA MLD and AP MLD are generally representative of any device capable of performing multi-link operations. FIG. 2 illustrates an example architecture of a MLD 200, according to one embodiment. The MLD 200 may be an AP MLD or a STA MLD. As depicted in FIG. 2, the MLD 200 provides a unique MAC instance to multiple wireless interfaces (e.g., wireless channels 250 1-N). The MLD 200 includes a logical link control (LLC) layer 210 and an upper MAC (U-MAC) layer 220. The upper MAC layer 220 is a common part of the MAC sub-layer for all the interfaces (e.g., wireless channels 250 1-N). The MLD 200 also includes a respective lower MAC (L-MAC) 230 1-N for each interface. Each respective L-MAC 230 manages a corresponding PHY layer 240 as well as link specific functionalities (e.g., channel access) for the corresponding wireless channel 250.

A MLD may generally be classified based on whether it is a single radio MLD or multi-radio MLD. Single radio MLDs generally use a single radio to switch between one or more links. One category of single radio MLDs is Enhanced Multi-Link Single Radio (eMLSR). eMLSR devices generally operate one main wireless radio that can transmit and/or receive data frames on a given link, but can detect some data (e.g., short initial frames) on a set of other links when the device is not actively transmitting or receiving. Multi-radio MLDs may generally be classified into the following two types: (i) simultaneous transmission and reception (STR) MLD and (ii) non-STR MLD. For STR MLDs, a transmission on one link may not affect the operations of frame reception and clear channel assessment (CCA) on other links. Stated differently, for STR MLDs, individual links can operate independently of each other. For non-STR MLDs, operation on one link may be restricted by operation on another link. For example, a transmission on one link may not be allowed if it will cause reception interruption on another link. In another example, a reception or CCA on one link may not be allowed if a transmission is ongoing on another link.

Referring back to FIG. 1, in certain embodiments, one or more of the APs 102 that are MLDs may be configured to support multiple VAPs. For example, as depicted in FIG. 1, AP 102-1 is a MLD that may operate VAP-1 170-1 to VAP-N 170-N. Each VAP may be associated with a different BSS, and each BSS may have a different (unique) BSS identifier (BSSID). For example, VAP-1 170-1 is associated with BSS-1 and VAP-N is associated with BSS-N. The AP 102-1 may include a multiple BSSID (MBSSID) capability that allows the AP to advertise information for multiple BSSIDs using a single management frame (e.g., beacon frame, probe response frame, etc.) as opposed to using multiple management frames (e.g., a separate management frame for each BSSID).

The AP 102-1 may support a certain number of MBSSID sets, where each MBSSID sets includes a respective subset of the VAPs 1-N. In one reference example, the AP 102-1 may support up to 4 MBSSID sets, where each MBSSID set supports up to 4 different VAPs. In certain embodiments, a given MBSSID and associated VAPs may be associated with a particular PHY mode. The PHY mode may include a wireless channel configuration, a supported frequency band (e.g., a 2.4 GHz band, a 5 GHz band, a 6 GHz band, etc.), a supported wireless communication standard (e.g., 802.11ax, 802.11be, etc.), or a combination thereof.

Within a given MBSSID set, the BSSID of one of the VAPs may be referred to as the “transmitted VAP” (or TxVAP or transmitted BSSID or TxBSSID) and the BSSID(s) of the rest of the VAPs may be referred to as “nontransmitted VAPs” (or non-Tx VAPs or nontransmitted BSSIDs or non-Tx BSSIDs). The BSSID of the VAP that transmits the management frame for all of the VAPs of the MBSSID set is referred to as the TxVAP. The BSSIDs of the VAPs that do not transmit the management frame are referred to as non-Tx VAPs. The non-Tx VAPs may advertise their management information in the management frame transmitted by the TxVAP. The management information (also referred to as information elements) that is advertised in the management frame may include elements, fields, capabilities, features, and other information that is associated with one or more of the BSSs.

In the embodiment depicted in FIG. 1, each BSS can have different wireless associations with client STAs 104. For example, a first client STA 104 can associate with a first BSSID corresponding to VAP-1 170-1 (associated with BSS1), a second client STA can associate with a second BSSID corresponding to VAP-2 170-2 (associated with BSS2), and so on. When a client STA (e.g., client STA 104-1) enters the vicinity of an AP, such as AP 102-1, the client STA may detect and inspect a management frame (e.g., beacon frame or probe response frame) to determine the BSSID(s) available from the AP. For example, the TxVAP of at least one MBSSID set (e.g., VAP-1 170-1) may periodically broadcast a beacon frame or may send a probe response frame that indicates (i) the BSSID of the TxVAP and (ii) the BSSIDs of one or more of the non-Tx VAPs within the MBSSID set.

As noted, one challenge with current implementations of MBSSID functionality is that all VAPs within a given MBSSID set generally have to have the same PHY mode and contiguous BSSID MAC addresses. Thus, when a VAP in a given MBSSID set is reconfigured to a different PHY mode than the other VAPs in the MBSSID set, the reconfigured VAP generally has to be moved to another MBSSID set.

Accordingly, in certain embodiments, a MLD device, such as AP 102-1 includes an assignment tool 150, which is configured to perform one or more techniques described herein for dynamically (re) assigning a VAP to a MBSSID set, based on a PHY mode associated with the VAP. In certain embodiments, the assignment tool 150 may obtain one or more VAP configurations 160 for the VAPs 1-N and generate one or more MBSSID sets, based on the VAP configurations 160. Each VAP configuration 160 may indicate a PHY mode for a VAP corresponding to the VAP configuration 160. The assignment tool 150 may assign VAPs to different MBSSID sets such that (i) the maximum number of VAPs (allowed by a wireless communication standard) can be supported without the need for reserving any MBSSID sets for reconfigured VAPs and (ii) other VAPs are not impacted when a given VAP's PHY mode changes.

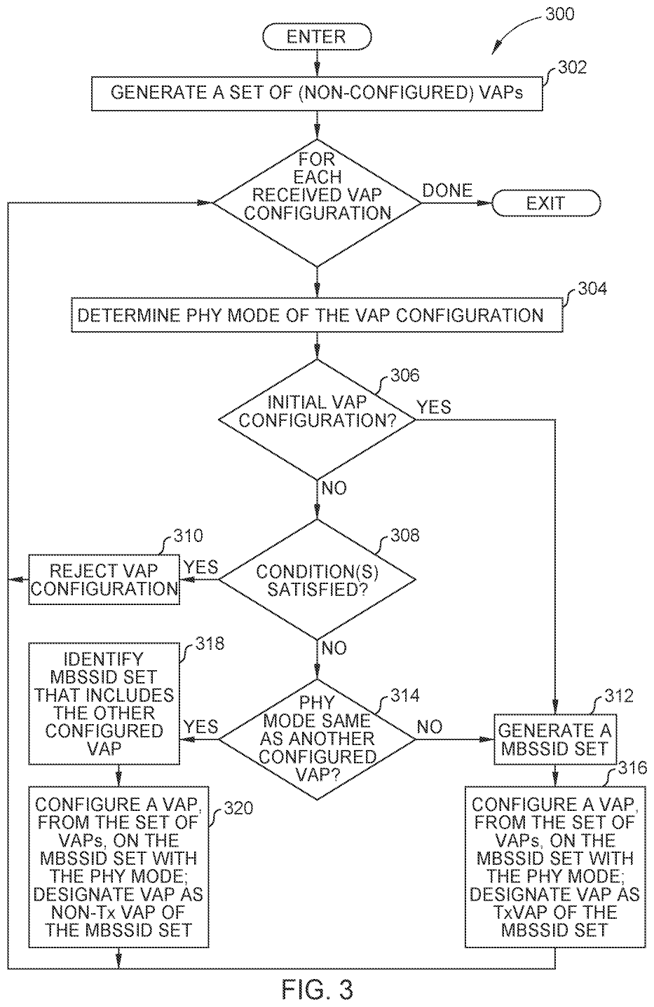

FIG. 3 is a flowchart of a method 300 for dynamically (re) assigning a VAP to a MBSSID set, based on a PHY mode associated with the VAP, according to one embodiment. The method 300 may be performed by an assignment tool (e.g., assignment tool 150).

Method 300 may enter at block 302, where the assignment tool generates (or creates) a set of (non-configured) VAPs. For example, when the AP (e.g., AP 102-1) boots up, the AP (via the assignment tool) may generate a set of blank (or empty) VAPs, where each VAP is initially without a configuration. In addition, at block 302, the assignment tool may refrain from generating a MBSSID set.

After performing block 302, the assignment tool may start receiving VAP configurations from a controller (e.g., controller 130) one VAP configuration at a time. For example, for each VAP configuration received from the controller, the assignment tool may perform one or more of blocks 304, 306, 308, 310, 312, 314, 316, 318, and 320. In certain embodiments, the VAP configuration received from the controller may be a VAP configuration for non-configured VAP (e.g., a non-configured VAP generated at block 302). In other embodiments, the VAP configuration received from the controller may be a VAP configuration for a re-configured VAP (e.g., a VAP that has been reconfigured to operate according to a different PHY mode).

At block 304, the assignment tool determines a PHY mode of the received VAP configuration. As noted, the PHY mode may include a wireless channel configuration, a supported frequency band (e.g., a 2.4 GHz band, a 5 GHz band, a 6 GHz band, etc.), a supported wireless communication standard (e.g., 802.11ax, 802.11be, etc.), or a combination thereof. At block 306, the assignment tool determines whether the received VAP configuration is an initial VAP configuration available for assignment. If the VAP configuration is an initial VAP configuration available for assignment, then the method 300 proceeds to block 312. If the VAP configuration is not an initial VAP configuration, then the method 300 proceeds to block 308.

At block 312, the assignment tool generates a MBSSID set (e.g., without any assigned VAPs). At block 316, the assignment tool configures a VAP, from the set of VAPs generated at block 302, on the generated MBSSID set with the PHY mode from the received VAP configuration. In addition, the assignment tool, at block 316, designates the VAP as a TxVAP of the MBSSID set.

At block 308, the assignment tool determines whether one or more conditions for halting VAP assignment is satisfied. In certain embodiments, the condition(s) may include (i) reaching a predetermined number of MBSSID sets supported by an AP or indicated by the controller, (ii) reaching a predetermined number of configured VAPs supported by an AP or indicated by the controller, (iii) reaching a predetermined number of configured VAPs with a certain PHY mode, or (iv) a combination thereof.

If, at block 308, the assignment tool determines that a condition for halting VAP assignment is satisfied, then the method 300 proceeds to block 310. At block 310, the assignment tool may reject the VAP configuration. For example, if the assignment tool determines that there are no available locations within any of the existing MBSSID sets for a received VAP configuration and no new MBSSID sets can be generated, then the assignment tool may reject the VAP configuration. In another example, if the assignment tool determines that a threshold number of VAPs with the same PHY mode as the received VAP configuration have been assigned, then the assignment tool may reject the VAP configuration.

Although not shown, in certain embodiments, the assignment tool, at block 310, may send an indication to the controller that the assignment tool (i) cannot accommodate receiving additional VAP configurations, (ii) cannot accommodate receiving additional VAP configurations with a certain PHY mode, (iii) can accommodate receiving additional VAP configurations along with an indication of the number of VAP configurations that can be accommodated, (iv) can accommodate receiving additional VAP configurations of one or more PHY modes along with an indication of the number of VAP configurations that can be accommodated, or (v) a combination thereof. For example, the assignment tool may indicate to the controller that up to 3 additional VAP configurations can be accommodated or that up to 3 additional VAP configurations with 802.11be PHY mode can be accommodated. Additionally, in certain embodiments, the assignment tool, at block 310, may send a request to the controller to reconfigure a rejected VAP configuration to use a different PHY mode that can be accommodated by the assignment tool. For example, the assignment tool may reject a VAP configuration having an 802.11ax PHY mode and request the controller to reconfigure the VAP configuration to use an 802.11be PHY mode. In certain embodiments, the assignment tool may be configured to reconfigure the VAP configuration to use a different PHY mode. Note, in such embodiments, the method 300 may proceed from block 310 to block 314 (not shown in FIG. 3).

If, at block 308, the assignment tool determines that a condition for halting VAP assignment is unsatisfied, then the method 300 proceeds to block 314. At block 314, the assignment tool determines whether the PHY mode is the same as another configured VAP. If the PHY mode is the same as another configured VAP, then the method 300 proceeds to block 312. On the other hand, if the PHY mode is not the same as another configured VAP, then the method 300 proceeds to block 318. At block 318, the assignment tool identifies the MBSSID set that includes the other configured VAP. At block 320, the assignment tool configures a VAP, from the set of VAPs, on the MBSSID set with the PHY mode. In addition, the assignment tool, at block 320, designates the VAP as a non-Tx VAP of the MBSSID set.

Advantageously, using the techniques described herein to dynamically (re) assign VAPs to MBSSID sets based on a PHY mode enables apparatus, such as an AP MLD, to refrain from reserving any MBSSID sets for reconfigured VAPs, thereby saving compute resources, and to avoid impacting other VAPs when a given VAP's PHY mode changes.

As a reference example, consider a scenario in which an AP boots up and creates a set of VAPs (e.g., 16 VAPs) without configuring the VAPs and without creating (or reserving) any MBSSIDs for the VAPs. Once the initial (first) VAP configuration is received from the controller, the AP may generate a first MBSSID set and configure a first VAP (from the set of VAPs) as a TxVAP on the first MBSSID set. In this example, the PHY mode of the first VAP configuration may indicate 802.11ax or 802.11be.

When a subsequent (second) VAP configuration is received from the controller, the AP may determine whether the PHY mode of the second VAP configuration is the same as the PHY mode of the first VAP configuration. The AP may configure a second VAP (from the 16 VAPs) with the PHY mode of the second VAP configuration. The AP may (i) add the second VAP into the first MBSSID set as a non-Tx VAP if the second VAP configuration has the same PHY mode as the first VAP configuration or (ii) generate a second MBSSID set and add the second VAP into the second MBSSID set as a TxVAP.

When a subsequent (third) VAP configuration is received from the controller, the AP may configure a third VAP (from the 16 VAPs) with the PHY mode of the third VAP configuration. The AP may then (i) add the third VAP into the first MBSSID set as a non-Tx VAP (e.g., if the third VAP configuration has a same PHY mode as the first VAP) or (ii) add the third VAP into the second MBSSID set as a non-Tx VAP (e.g., if the third VAP configuration has a same PHY mode as the second VAP).

The AP may continue this process of assigning VAPs to MBSSIDs, based on PHY mode until (i) the maximum number of VAPs (e.g., 16 VAPs) have been assigned to MBSSID sets or the number of VAPs configured on the controller have been assigned to MBSSID sets, (ii) the maximum number of MBSSID sets have been created, or (iii) a combination thereof. In certain embodiments, when one or more of the aforementioned conditions is satisfied, the AP may reject new VAP configurations received from the controller.

In certain embodiments, after a threshold number of VAPs have been assigned to MBSSID sets, the AP may be configured to prioritize assigning certain VAP configurations with a predefined PHY mode and reject other VAP configurations with a different PHY mode. For example, assuming the AP receives a VAP configuration with an 802.11be PHY mode after assigning 8 VAPs (e.g., threshold=8) with 802.11be PHY mode to 2 MBSSID sets (each with 4 VAPs), the AP may reject the VAP configuration with 802.11be PHY mode or reconfigure the VAP configuration to an 802.11ax PHY mode. In situations where the AP reconfigures the VAP configuration, the AP may transmit an indication to the controller that the AP cannot accommodate receiving additional VAP configurations with an 802.11be PHY mode, but that the AP can accommodate receiving additional VAP configurations with an 802.11ax PHY mode.

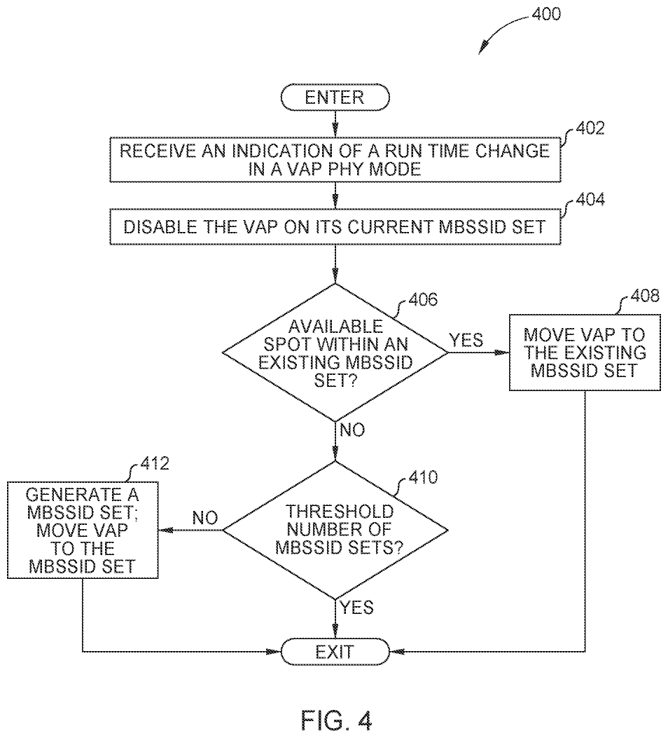

FIG. 4 is a flowchart of another method 400 for dynamically (re) assigning a VAP to a MBSSID set, based on a PHY mode associated with the VAP, according to one embodiment. The method 400 may be performed by an assignment tool (e.g., assignment tool 150). In certain embodiments, the method 400 is performed during runtime of a computing device, such as AP 102-1.

Method 400 may enter at block 402, where the assignment tool receives an indication of a run time change in a VAP's PHY mode. For example, the VAP's PHY mode may be changed from a first PHY mode (e.g., 802.11be) to a second PHY mode (e.g., 802.11ax). In certain examples, the controller may trigger a change in the PHY mode at the radio level or band level. In another example, the AP may trigger the change in the PHY mode. For instance, the AP may disable certain functionality (e.g., disable 802.11be functionality) on a guest MBSSID to alleviate interoperability issues with client STAs.

At block 404, the assignment tool disables the VAP on its current MBSSID set, e.g., in response to receiving the indication of the run time change. At block 406, the assignment tool determines whether there is an available (or empty) location within another existing MBSSID set that is associated with the changed PHY mode of the VAP. If so, then the assignment tool moves the VAP to the available location within the existing MBSSID set (block 408). On the other hand, if, at block 406, the assignment tool determines there are no available locations within existing MBSSID set(s), then the method 400 proceeds to block 410.

At block 410, the assignment tool determines whether a threshold number of MBSSID sets exist. Here, at block 410, if the assignment tool determines that a threshold number of MBSSID sets exists, then the assignment tool determines that another MBSSID set cannot be generated and may keep the VAP disabled on its current MBSSID set. On the other hand, if the assignment tool determines that a threshold number of MBSSID sets has not been reached, then the assignment tool generates a (new) MBSSID set and moves the VAP to the new MBSSID set as a TxVAP (block 412).

In certain embodiments, the techniques described herein may (re) assign BSSID MAC addresses to VAPs, based on the location within the MBSSID set to which the VAP is assigned. For example, when the assignment tool creates a MBSSID set, the assignment tool may assign each available location within the MBSSID set a (unique) BSSID MAC address. Additionally, when a VAP is (re) assigned to a given location within the MBSSID set, the VAP may be (re) assigned the BSSID MAC address associated with that location.

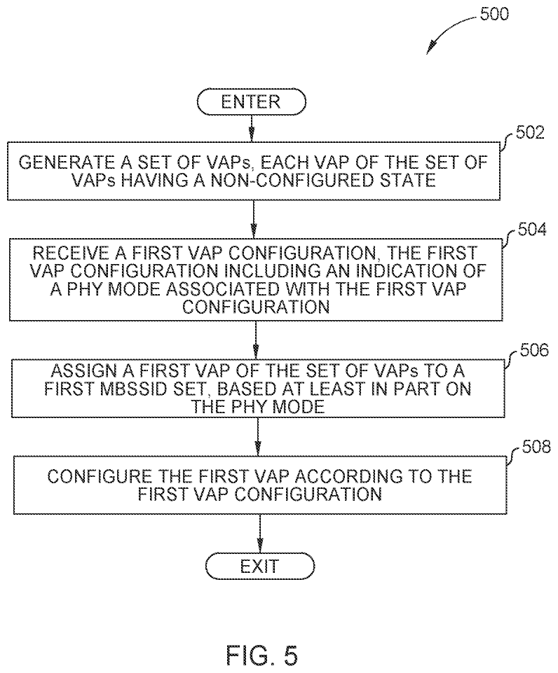

FIG. 5 is a flowchart of a method 500 for dynamically (re) assigning VAPs to MBSSID sets, based on a respective PHY mode associated with each VAP, according to one embodiment. The method 500 may be performed by an assignment tool (e.g., assignment tool 150).

Method 500 enters at block 502, where the assignment tool generates a set of VAPs, where each VAP of the set of VAPs has a non-configured state.

At block 504, the assignment tool receives a first VAP configuration. The first VAP configuration includes an indication of a PHY mode associated with the first VAP configuration. In certain embodiments, the PHY mode includes at least one of (i) a wireless channel configuration, (ii) an indication of one or more supported frequency bands, or (iii) an indication of one or more supported wireless communication standards.

At block 506, the assignment tool assigns a first VAP of the set of VAPs to a first MBSSID set, based at least in part on the PHY mode. In certain embodiments, the first MBSSID set is generated after receiving the first VAP configuration. The first MBSSID set may include a plurality of locations for assigning a respective plurality of VAPs. In certain embodiments, the first VAP may be designated as a TxVAP of the first MBSSID (e.g., if the first VAP is the initial VAP assigned to the first MBSSID set). In certain embodiments, the first VAP may be designated as a non-Tx VAP of the first MBSSID set (e.g., if the first VAP is not the initial VAP assigned to the first MBSSID set). Each VAP assigned to the first MBSSID set may be associated with a same PHY mode.

At block 508, the assignment tool configures the first VAP according to the first VAP configuration.

In certain embodiments, the assignment tool as part of method 500 may further: (i) receive a second VAP configuration that includes an indication of a PHY mode associated with the second VAP configuration; (ii) assign a second VAP of the set of VAPs to the first MBSSID set upon determining the PHY mode associated with the second VAP configuration is the same as the PHY mode associated with the first VAP configuration; and (iii) configure the second VAP according to the second VAP configuration.

In certain embodiments, the assignment tool as part of method 500 may further: (i) receive a second VAP configuration that includes an indication of a PHY mode associated with the second VAP configuration; (ii) assign a second VAP of the set of VAPs to a second MBSSID set different from the first MBSSID set, upon determining the PHY mode associated with the second VAP configuration is different from the PHY mode associated with the first VAP configuration; and (iii) configure the second VAP according to the second VAP configuration.

In certain embodiments, the assignment tool as part of method 500 may further: (i) receive an indication of a change in the PHY mode associated with the first VAP configuration; and (ii) in response to the indication of the change in the PHY mode associated with the first VAP configuration: disable the first VAP in the first MBSSID set; and reassign the first VAP to a second MBSSID set, based on the change in the PHY mode. In such embodiments, the second MBSSID set may include a second VAP designated as a transmitted VAP within the second MBSSID set, and the first VAP may be designated as a non-transmitted VAP within the second MBSSID set. In other such embodiments, the assignment tool may generate the second MBSSID set after disabling the first VAP and may designate the first VAP as a transmitted VAP within the second MBSSID set.

FIG. 6 illustrates an example computing device 600, according to one embodiment. The computing device 600 can be configured to perform one or more techniques described herein for dynamically (re) assigning VAPs to MBSSID sets, based on PHY mode. For example, the computing device 600 can perform method 300, method 400, method 500, and any other techniques (or combination of techniques) described herein. In certain embodiments, the computing device 600 is an MLD, such as an AP (e.g., AP 102-1). The computing device 600 includes, without limitation, a processor 610, a memory 620, one or more radios 630a-n (generally, radio 630), and storage 640.

The processor 610 may be any processing element capable of performing the functions described herein. The processor 610 represents a single processor, multiple processors, a processor with multiple cores, and combinations thereof. The communication interfaces 630 facilitate communications between the computing device 600 and other devices. The communications interfaces 630 are representative of wireless communications antennas and various wired communication ports.

The memory 620 may be either volatile or non-volatile memory and may include RAM, flash, cache, disk drives, and other computer readable memory storage devices. Although shown as a single entity, the memory 620 may be divided into different memory storage elements such as RAM and one or more hard disk drives. As shown, the memory 620 includes various instructions that are executable by the processor 610 to provide an operating system 622 to manage various functions of the computing device 600. The memory 620 also includes an assignment tool 150 configured to perform one or more techniques described herein.

The storage 640 may be a disk drive storage device. Although shown as a single unit, the storage 640 may be a combination of fixed and/or removable storage devices, such as fixed disc drives, removable memory cards, or optical storage, network attached storage (NAS), or a storage area-network (SAN). In certain embodiments, the storage 640 may include, without limitation, one or more VAP configurations 160, one or more MBSSID sets 642, and one or more VAPs 170. Each MBSSID set 642 may include one or more locations 644 to which a respective one or more VAPs 170 can be assigned. Each location 644 may be associated with a unique BSSID MAC address.

In the current disclosure, reference is made to various embodiments. However, the scope of the present disclosure is not limited to specific described embodiments. Instead, any combination of the described features and elements, whether related to different embodiments or not, is contemplated to implement and practice contemplated embodiments. Additionally, when elements of the embodiments are described in the form of “at least one of A and B,” or “at least one of A or B,” it will be understood that embodiments including element A exclusively, including element B exclusively, and including element A and B are each contemplated. Furthermore, although some embodiments disclosed herein may achieve advantages over other possible solutions or over the prior art, whether or not a particular advantage is achieved by a given embodiment is not limiting of the scope of the present disclosure. Thus, the aspects, features, embodiments and advantages disclosed herein are merely illustrative and are not considered elements or limitations of the appended claims except where explicitly recited in a claim(s). Likewise, reference to “the invention” shall not be construed as a generalization of any inventive subject matter disclosed herein and shall not be considered to be an element or limitation of the appended claims except where explicitly recited in a claim(s).

As used herein, “a processor,” “at least one processor,” or “one or more processors” generally refers to a single processor configured to perform one or multiple operations or multiple processors configured to collectively perform one or more operations. In the case of multiple processors, performance of the one or more operations could be divided amongst different processors, though one processor may perform multiple operations, and multiple processors could collectively perform a single operation. Similarly, “a memory,” “at least one memory,” or “one or more memories” generally refers to a single memory configured to store data and/or instructions or multiple memories configured to collectively store data and/or instructions.

As will be appreciated by one skilled in the art, the embodiments disclosed herein may be embodied as a system, method or computer program product. Accordingly, embodiments may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, embodiments may take the form of a computer program product embodied in one or more computer readable medium(s) having computer readable program code embodied thereon.

Program code embodied on a computer readable medium may be transmitted using any appropriate medium, including but not limited to wireless, wireline, optical fiber cable, RF, etc., or any suitable combination of the foregoing.

Computer program code for carrying out operations for embodiments of the present disclosure may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present disclosure are described herein with reference to flowchart illustrations and/or block diagrams of methods, apparatuses (systems), and computer program products according to embodiments presented in this disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the block(s) of the flowchart illustrations and/or block diagrams.

These computer program instructions may also be stored in a computer readable medium that can direct a computer, other programmable data processing apparatus, or other device to function in a particular manner, such that the instructions stored in the computer readable medium produce an article of manufacture including instructions which implement the function/act specified in the block(s) of the flowchart illustrations and/or block diagrams.

The computer program instructions may also be loaded onto a computer, other programmable data processing apparatus, or other device to cause a series of operational steps to be performed on the computer, other programmable apparatus or other device to produce a computer implemented process such that the instructions which execute on the computer, other programmable data processing apparatus, or other device provide processes for implementing the functions/acts specified in the block(s) of the flowchart illustrations and/or block diagrams.

The flowchart illustrations and block diagrams in the Figures illustrate the architecture, functionality, and operation of possible implementations of systems, methods, and computer program products according to various embodiments. In this regard, each block in the flowchart illustrations or block diagrams may represent a module, segment, or portion of code, which comprises one or more executable instructions for implementing the specified logical function(s). It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustrations, and combinations of blocks in the block diagrams and/or flowchart illustrations, can be implemented by special purpose hardware-based systems that perform the specified functions or acts, or combinations of special purpose hardware and computer instructions.

In view of the foregoing, the scope of the present disclosure is determined by the claims that follow.

We claim:

1. A computer-implemented method comprising:
generating a set of virtual access points (VAPs), each VAP of the set of VAPs having a non-configured state;
receiving a first virtual access point (VAP) configuration, the first VAP configuration comprising an indication of a physical (PHY) mode associated with the first VAP configuration;
assigning a first VAP of the set of VAPs to a first multiple basic service set identifier (MBSSID) set, based at least in part on the PHY mode; and
configuring the first VAP according to the first VAP configuration.

2. The computer-implemented method of claim 1, further comprising:
receiving a second VAP configuration, the second VAP configuration comprising an indication of a PHY mode associated with the second VAP configuration;
upon determining the PHY mode associated with the second VAP configuration is the same as the PHY mode associated with the first VAP configuration, assigning a second VAP of the set of VAPs to the first MBSSID set; and
configuring the second VAP according to the second VAP configuration.

3. The computer-implemented method of claim 1, further comprising:
receiving a second VAP configuration, the second VAP configuration comprising an indication of a PHY mode associated with the second VAP configuration;
upon determining the PHY mode associated with the second VAP configuration is different from the PHY mode associated with the first VAP configuration, assigning a second VAP of the set of VAPs to a second MBSSID set different from the first MBSSID set; and
configuring the second VAP according to the second VAP configuration.

4. The computer-implemented method of claim 1, wherein the PHY mode comprises at least one of (i) a wireless channel configuration, (ii) an indication of one or more supported frequency bands, or (iii) an indication of one or more supported wireless communication standards.

5. The computer-implemented method of claim 1, further comprising:
receiving an indication of a change in the PHY mode associated with the first VAP configuration; and
in response to the indication of the change in the PHY mode associated with the first VAP configuration:
disabling the first VAP in the first MBSSID set; and
reassigning the first VAP to a second MBSSID set, based on the change in the PHY mode.

6. The computer-implemented method of claim 5, wherein:
the second MBSSID set comprises a second VAP designated as a transmitted VAP within the second MBSSID set; and
the first VAP is designated as a non-transmitted VAP within the second MBSSID set.

7. The computer-implemented method of claim 5, further comprising generating the second MBSSID set after disabling the first VAP, wherein the first VAP is designated as a transmitted VAP within the second MBSSID set.

8. A computing device comprising:
one or more memories collectively storing computer-executable instructions; and
one or more processors coupled to the one or more memories, the one or more processors being collectively configured to execute the computer-executable instructions to cause the computing device to perform an operation comprising:
generating a set of virtual access points (VAPs), each VAP of the set of VAPs having a non-configured state;
receiving a first virtual access point (VAP) configuration, the first VAP configuration comprising an indication of a physical (PHY) mode associated with the first VAP configuration;
assigning a first VAP of the set of VAPs to a first multiple basic service set identifier (MBSSID) set, based at least in part on the PHY mode; and
configuring the first VAP according to the first VAP configuration.

9. The computing device of claim 8, the operation further comprising:
receiving a second VAP configuration, the second VAP configuration comprising an indication of a PHY mode associated with the second VAP configuration;
upon determining the PHY mode associated with the second VAP configuration is the same as the PHY mode associated with the first VAP configuration, assigning a second VAP of the set of VAPs to the first MBSSID set; and
configuring the second VAP according to the second VAP configuration.

10. The computing device of claim 8, the operation further comprising:
receiving a second VAP configuration, the second VAP configuration comprising an indication of a PHY mode associated with the second VAP configuration;
upon determining the PHY mode associated with the second VAP configuration is different from the PHY mode associated with the first VAP configuration, assigning a second VAP of the set of VAPs to a second MBSSID set different from the first MBSSID set; and
configuring the second VAP according to the second VAP configuration.

11. The computing device of claim 8, wherein the PHY mode comprises at least one of (i) a wireless channel configuration, (ii) an indication of one or more supported frequency bands, or (iii) an indication of one or more supported wireless communication standards.

12. The computing device of claim 8, the operation further comprising:
receiving an indication of a change in the PHY mode associated with the first VAP configuration; and
in response to the indication of the change in the PHY mode associated with the first VAP configuration:
disabling the first VAP in the first MBSSID set; and
reassigning the first VAP to a second MBSSID set, based on the change in the PHY mode.

13. The computing device of claim 12, wherein:
the second MBSSID set comprises a second VAP designated as a transmitted VAP within the second MBSSID set; and
the first VAP is designated as a non-transmitted VAP within the second MBSSID set.

14. The computing device of claim 12, the operation further comprising generating the second MBSSID set after disabling the first VAP, wherein the first VAP is designated as a transmitted VAP within the second MBSSID set.

15. One or more non-transitory computer-readable storage media containing, in any combination, computer-executable instructions that, when executed by a computing system, perform an operation comprising:
generating a set of virtual access points (VAPs), each VAP of the set of VAPs having a non-configured state;
receiving a first virtual access point (VAP) configuration, the first VAP configuration comprising an indication of a physical (PHY) mode associated with the first VAP configuration;
assigning a first VAP of the set of VAPs to a first multiple basic service set identifier (MBSSID) set, based at least in part on the PHY mode; and
configuring the first VAP according to the first VAP configuration.

16. The one or more non-transitory computer-readable storage media of claim 15, the operation further comprising:
receiving a second VAP configuration, the second VAP configuration comprising an indication of a PHY mode associated with the second VAP configuration;
upon determining the PHY mode associated with the second VAP configuration is the same as the PHY mode associated with the first VAP configuration, assigning a second VAP of the set of VAPs to the first MBSSID set; and
configuring the second VAP according to the second VAP configuration.

17. The one or more non-transitory computer-readable storage media of claim 15, the operation further comprising:
receiving a second VAP configuration, the second VAP configuration comprising an indication of a PHY mode associated with the second VAP configuration;
upon determining the PHY mode associated with the second VAP configuration is different from the PHY mode associated with the first VAP configuration, assigning a second VAP of the set of VAPs to a second MBSSID set different from the first MBSSID set; and
configuring the second VAP according to the second VAP configuration.

18. The one or more non-transitory computer-readable storage media of claim 15, the operation further comprising:
receiving an indication of a change in the PHY mode associated with the first VAP configuration; and
in response to the indication of the change in the PHY mode associated with the first VAP configuration:
disabling the first VAP in the first MBSSID set; and
reassigning the first VAP to a second MBSSID set, based on the change in the PHY mode.

19. The one or more non-transitory computer-readable storage media of claim 18, wherein:
the second MBSSID set comprises a second VAP designated as a transmitted VAP within the second MBSSID set; and
the first VAP is designated as a non-transmitted VAP within the second MBSSID set.

20. The one or more non-transitory computer-readable storage media of claim 19, the operation further comprising generating the second MBSSID set after disabling the first VAP, wherein the first VAP is designated as a transmitted VAP within the second MBSSID set.
